(19) United States
(12) Patent Application Publication
(10) Pub. No.: US 2008/0060886 A1
(43) Pub. Date: Mar. 13, 2008

(54) Wheeled vehicle support

(76) Inventor: Glenn Alan Erghott, Long Valley, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(21) Appl. No.: 11/517,534

(22) Filed: Sep. 7, 2006

(51) Int. Cl. B60T 3/00

(52) U.S. Cl. 188/32

(57) ABSTRACT

Disclosed are systems and methods for supporting a wheeled vehicle in a stationary and/or upright orientation. In one aspect of the present invention, a self-locking rear brace is coupled with an adjustable front brace to provide a plurality of contact points between the vehicle support and a wheel contained therein. In another aspect of the present invention, a stabilizer is provided to accommodate freestanding use of the vehicle support. In another aspect, the components of the vehicle support are easily removable to accommodate loading of a plurality of vehicles in an aligned manner. Also disclosed are rear braces including extensions for providing lateral support to a wheel contained within the vehicle support.

### BACKGROUND OF THE INVENTION

Embodiments of the present invention relate generally to systems and methods for supporting a wheeled vehicle in a stationary and/or upright orientation. More specifically, the present invention relates to systems and methods for supporting a wheeled vehicle in a stationary and/or upright orientation via a single, self-locking wheel support that supports a wheel contained therein at a plurality of contact points.

Systems and methods for maintaining a vehicle, such as a motorcycle, in an upright position are known in the art. One such system is a motorcycle stand for use with a motorcycle lift. The stand includes a frame and a wheel locking assembly. The frame includes a longitudinal wheel way along which the wheel of the motorcycle may be rolled. The wheel locking assembly includes a concave pivoting saddle and an immovable and irremovable wheel stop, both of which are mounted to the frame. During use, the wheel of a vehicle is rolled through the saddle until its forward facing end contacts the wheel stop. During this motion, the saddle pivots due to the force exerted by the vehicle upon the saddle. This pivoting holds the wheel between the saddle and the wheel stop, thereby maintaining the vehicle associated therewith in an upright position.

Another motorcycle stand including a primary capture mechanism and an upper engagement shoe are also known in the art. The primary capture mechanism includes a transverse rod upon which are mounted two vertical capture plates and one concave horizontal tire contact plate. When a wheel of a vehicle to be held upright by this stand is rolled into contact with the primary capture mechanism, the vertical capture plates and horizontal concave tire contact plate rotate. Such motion is caused by the spring action and location of a pair of compressible pivot rods, wherein a first end of such pivot rods are mounted to the sides of the vertical capture plates and a second end of such pivot rods are mounted external to the path of rotation of such capture plates. Rotation of the vertical capture plates results in contact between such plates and the sidewalls of the wheel contained therein. Further rotation of the vertical capture plates results in compression of the springs in the pivot rods, thereby exerting latitudinal force on the vertical contact plates and the wheel contained therein. The upper engagement shoe further supports the contained wheel at a point approximately one hundred and eighty degrees (relative to the circumference of the wheel) from the vertical contact plates.

### BRIEF SUMMARY OF THE INVENTION

Briefly stated, in one aspect of the present invention, a wheeled vehicle support is provided. This support includes a frame, a front brace coupled to the frame, and a rear brace coupled to the frame, wherein the support supports a wheeled vehicle in at least one of the group consisting of a stationary position, an upright position, and combinations thereof, and wherein a position of the front brace is longitudinally adjustable along the frame.

In another aspect of the present invention, another wheeled vehicle support is provided. This support includes a frame, a front brace removably coupled to the frame, and a rear brace removably coupled to the frame, wherein the support supports a wheeled vehicle in at least one of the group consisting of a stationary position, an upright position, and combinations thereof, and wherein the frame provides an unobstructed pathway for one or more wheels of the wheeled vehicle whenever the front brace and the rear brace are removed from the frame.

In yet another aspect of the present invention, an additional wheeled vehicle support is provided. This support includes a frame, a front brace coupled to the frame, and a rear brace coupled to the frame, wherein the support supports a wheeled vehicle in at least one of the group consisting of a stationary position, an upright position, and combinations thereof, and wherein at least one of the group consisting of the front brace, the rear brace, and combinations thereof includes at least one aperture to facilitate attachment of a fastening mechanism.

Also provided is a wheeled vehicle support including a frame, a front brace coupled to the frame, the front brace including at least one ratchet strap brace, and a rear brace coupled to the frame, the rear brace including at least one ratchet strap brace, wherein the support supports a wheeled vehicle in at least one of the group consisting of a stationary position, an upright position, and combinations thereof, and wherein the ratchet strap braces facilitate attachment of at least one ratchet strap to the support.

Further provided is a wheeled vehicle support including a frame, a front brace coupled to the frame, a rear brace coupled to the frame, at least one retention mechanism for coupling at least one of the group consisting of the front brace, the rear brace, and at least one accessory to the frame, wherein the frame includes at least two apertures for receiving the at least one retention mechanism, and wherein the support supports a wheeled vehicle in at least one of the group consisting of a stationary position, an upright position, and combinations thereof.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 is a perspective view of a vehicle support in accordance with one embodiment of the present invention;

FIG. 2A is a perspective view of the frame of the vehicle support depicted in FIG. 1;

FIG. 2B is a perspective view of a vehicle support frame in accordance with an alternate embodiment of the present invention;

FIG. 2C is a perspective view of a vehicle support frame in accordance with another alternate embodiment of the present invention;

FIG. 3 is a top plan view of the front brace of the vehicle support depicted in FIG. 1 in contact with a tire;

FIG. 4A is a perspective view of a front brace in accordance with an alternate embodiment of the present invention;

FIG. 4B is a top plan view of the front brace depicted in FIG. 4A in contact with a tire;

FIG. 4C is a top plan view of a front brace in accordance with another alternate embodiment of the present invention;

FIG. 4D is a top plan view of a front brace in accordance with another alternate embodiment of the present invention;

FIG. 5A is a top plan view of a sheet of material and associated bend lines used to create a rear brace in accordance with one embodiment of the present invention;

FIG. 5B is a perspective view of a rear brace created from the sheet of material depicted in FIG. 5A;

FIG. 5C is a top plan view of a notched sheet of material and associated bend lines used to create a rear brace in accordance with one embodiment of the present invention;

FIG. 5D is a perspective view of a rear brace created from the notched sheet of material depicted in FIG. 5C;

FIG. 5E is a top plan view of two sheets of material and associated bend lines used to create a rear brace in accordance with one embodiment of the present invention;

FIG. 5F is a perspective view of a rear brace created from the two sheets of material depicted in FIG. 5E;

FIG. 5G is a perspective view of a rear brace having extensions in accordance with one embodiment of the present invention;

FIG. 6A is a right side view of the vehicle support depicted in FIG. 1 including a loaded wheel;

FIG. 6B is a left side view of the vehicle support depicted in FIG. 1 including a loaded wheel;

FIG. 7A is a perspective view of a vehicle being loaded through a rear vehicle support into a front vehicle support;

FIG. 7B is a top plan view of a trailer including three vehicle supports, each having a vehicle loaded therein, and one vehicle support frame with all other components removed;

FIG. 8A is an exploded view of the attachment of a winch to a frame in accordance with one embodiment of the present invention;

FIG. 8B is a perspective view of a winch mounted to a frame in accordance with one embodiment of the present invention;

FIG. 9A is an exploded view of ratchet straps prior to attachment to a vehicle support having ratchet strap braces in accordance with one embodiment of the present invention;

FIG. 9B is a perspective view of the vehicle support depicted in FIG. 9A with ratchet straps attached thereto;

FIG. 10 is an exploded view of a vehicle support frame cover in accordance with one embodiment of the present invention;

FIG. 11A is a perspective view of a vehicle support frame for narrow tires in accordance with one embodiment of the present invention;

FIG. 11B is a perspective view of a vehicle support frame for wide tires in accordance with one embodiment of the present invention; and

FIG. 11C is a perspective view of a vehicle support frame for wide tires in accordance with an alternate embodiment of the present invention.

### DETAILED DESCRIPTION OF THE INVENTION

Certain terminology is used in the following description for convenience only and is not limiting. The words “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an aperture” includes a plurality of apertures. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

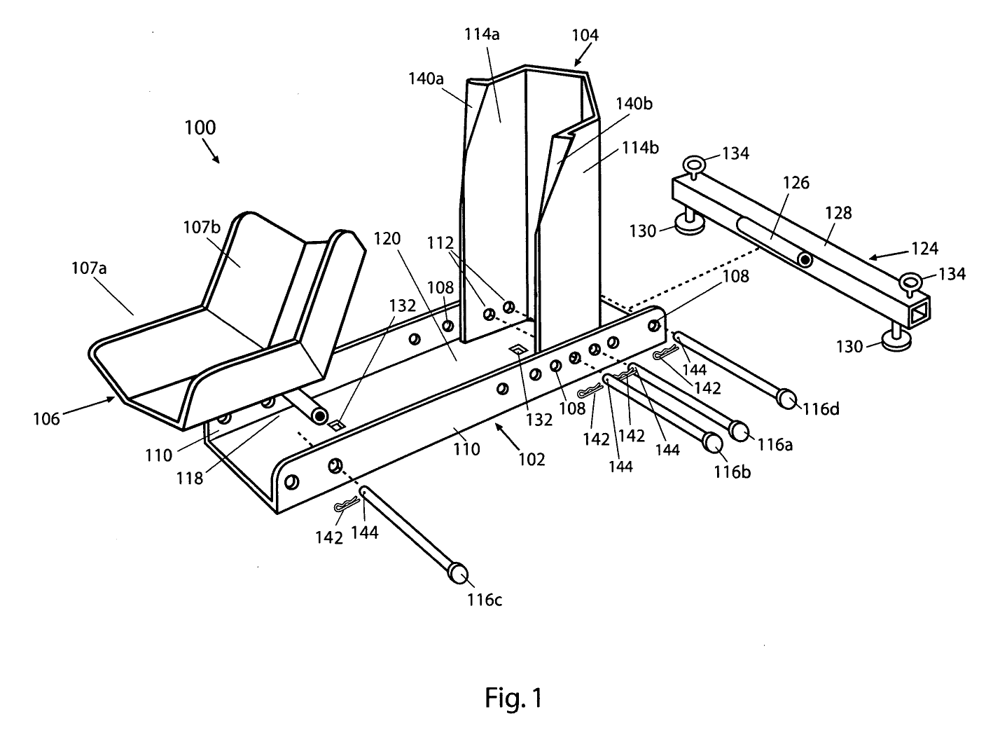

Referring first to FIG. 1, depicted is vehicle support 100 in accordance with one embodiment of the present invention. Vehicle support 100 includes, inter alia, frame 102, front brace 104, rear brace 106, and stabilizer 124. Vehicle support 100 may be used to retain a wheeled vehicle (e.g., vehicles have two, three, four, or more wheels) such as a motorcycle, scooter, motor scooter, moped, tricycle, a quad vehicle, lawnmower, and the like in a stationary and/or upright position during periods of non-use for purposes including, but not limited to, preventing damage thereto, transporting said vehicle, etc. However, the size and/or dimensions of the vehicle support may vary depending upon the size of the vehicle, or components thereof, with which it will be used.

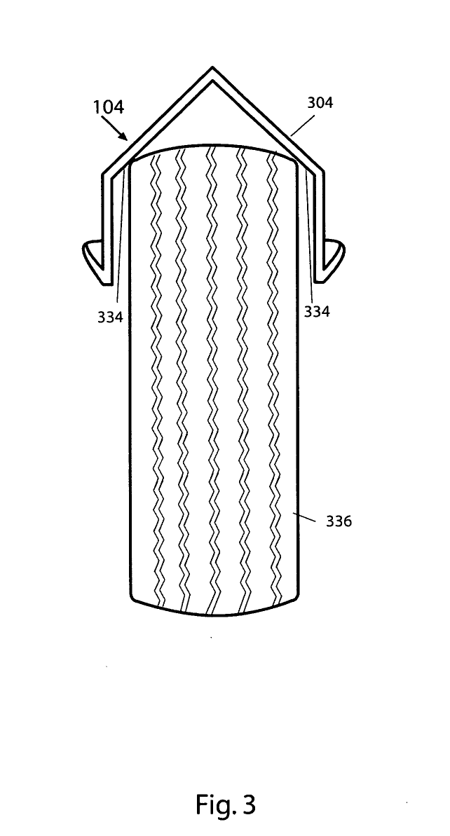

Vehicle support 100 may be most easily explained by first understanding its method of use. When a user of vehicle support 100 wishes to support a vehicle via vehicle support 100, either the front or rear wheel of the vehicle is rolled over rear brace 106 and through the longitudinal channel formed between frame sides 110 of frame 102 until the tire of the wheel, such as tire 336 (FIG. 3), contacts inwardly facing surfaces 334 of front brace 104, as depicted in FIG. 3. At the point at which the tire contacts front brace 104, the force of the weight of the tire and the associated wheel, as well as the force applied to the respective tire and wheel by the weight of the vehicle due to gravity causes rear brace 106 to pivot with respect to rear brace coupling 118 to a position in which rear brace 106, in addition to front brace 104, retain the wheel, and therefore the vehicle, in a stationary and/or upright position.

It should be noted that the vehicle support of the present invention may be used to load a vehicle in either a forward or backward direction without modification thereof. Also, the flexibility of this design allows the vehicle support of the present invention to be mounted or rested upon an approximately horizontal surface in a manner that accommodates forward or backward loading of the vehicle by simply changing the orientation of the vehicle support prior to mounting or resting same. That is, once a user determines the direction from which he or she wishes to load the vehicle into the vehicle support, the user simply orients the vehicle support such that the vehicle will contact the rear brace first and the front brace second.

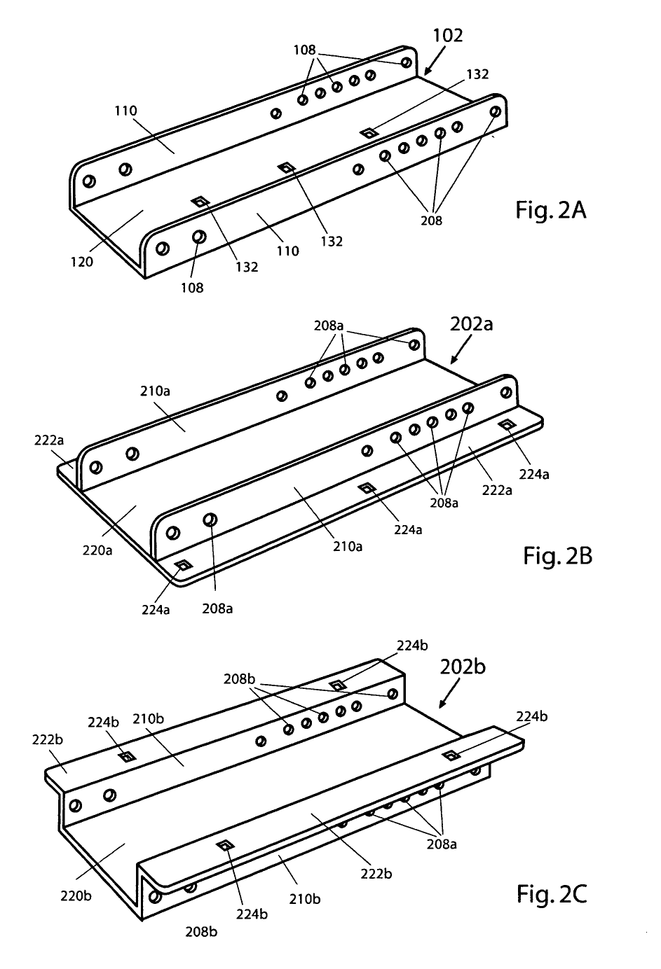

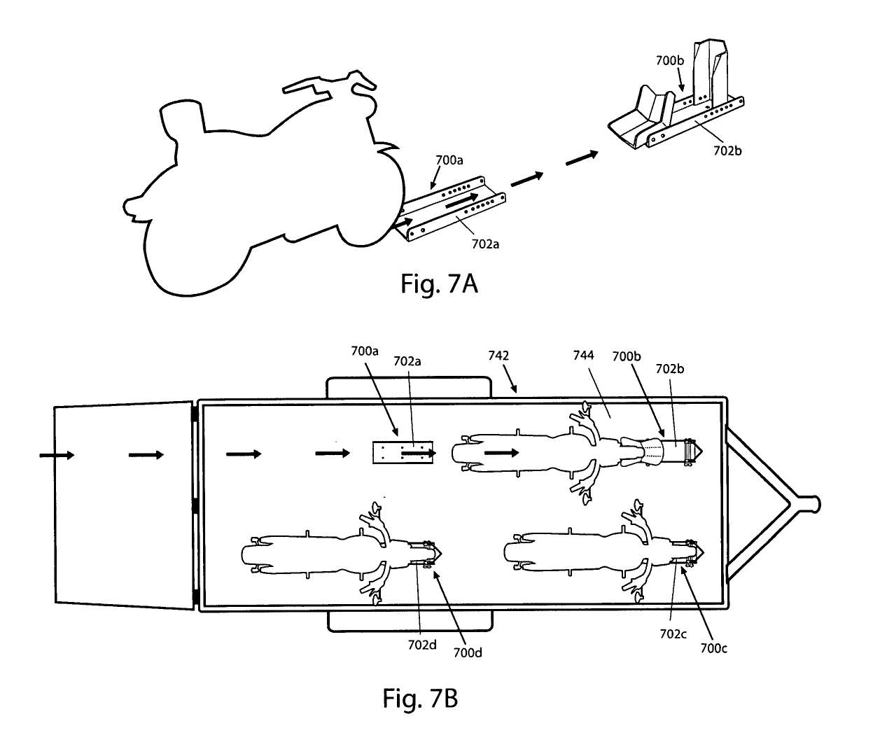

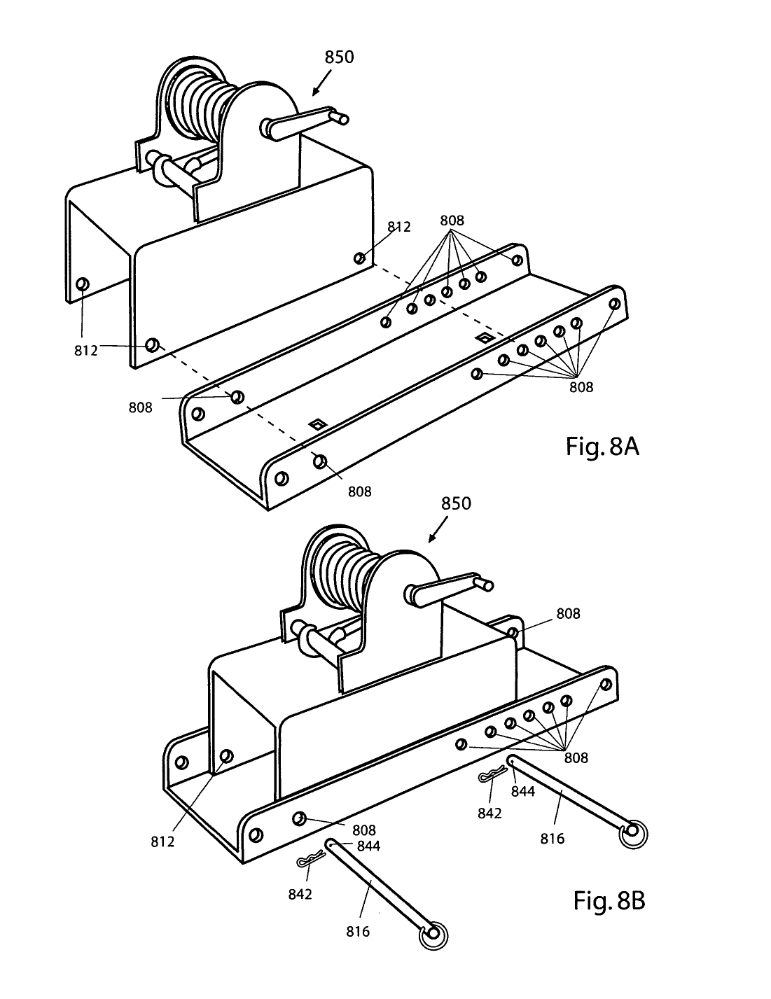

Referring next to FIG. 2A, frame 102 is depicted with front and rear braces 104 and 106, respectively, and stabilizer 124 removed. In the depicted embodiment of the present invention, frame 102 is a U-shaped channel including a plurality of frame side apertures 108 aligned longitudinally along frame sides 110 of frame 102. The downwardly facing longitudinal edges of frame sides 110 are coupled to frame floor 120. As seen in FIG. 2A, the design of frame 102 provides an unobstructed pathway through which a wheeled vehicle may be rolled. That is, the wheeled vehicle may be rolled along the longitudinal length of frame floor 120. Such pathway accommodates loading of a wheel into a vehicle support as well as rolling a vehicle through frame 102 as discussed in greater detail below with respect to FIGS. 7A and 7B. Although FIG. 2A depicts frame 102 having a frame floor 120 that extends throughout the entire length of frame 102, alternate embodiments are envisioned in which frame floor 120 extends only partially throughout the length of frame 102, or wherein frame floor 120 is notched or otherwise disrupted without departing from the scope of the present invention. For example, frame floor 102 may be notched such that the outwardly facing surface of second rear brace section 107b contacts the surface upon which frame 102 is mounted rather than frame floor 102.

In its most simplistic form, frame 102 may be fabricated from a single approximately rectangular sheet of material by forming two longitudinal bends such that two frame sides are formed, wherein such frame sides are approximately perpendicular to the frame floor. However, alternate embodiments are envisioned in which multiple pieces are attached together via welding or the like. Or, in other embodiments, frame 102 may be formed as a single piece via injection molding, aluminum extrusion, or the like. However, such methods of manufacturing frame 102 are exemplary only and other methods may be substituted without departing from the scope of the present invention.

Furthermore, in its most simplistic form, frame 102 may include four frame side apertures 108 for mounting of front and rear braces 104 and 106, respectively, thereto. Also, optionally, frame 102 may include one or more frame floor apertures 132 for mounting frame 102 to an approximately horizontal surface upon which frame 102 rests. However, alternate embodiments (such as that depicted in FIG. 1) are envisioned in which a greater quantity of frame side and/or frame floor apertures are provided to facilitate adjustment of front and/or rear braces 104 and 106, respectively, attachment of a stabilizer such as stabilizer 124, and/or mounting of frame 102 to the approximately horizontal surface upon which it rests as discussed in greater detail herein.

Frame 102, as well as the other components of vehicle support 100 (e.g., front and rear braces 104 and 106, respectively, stabilizer 124, etc.) may be fabricated from virtually any type of material capable of supporting the pressure and/or force that will be applied by the weight of the vehicle with which the vehicle support will be used. Such pressure may vary for each component of vehicle support 100 based upon the portion of the vehicle that will apply pressure to the particular component. In some embodiments of the present invention, the components of vehicle support 100 are fabricated from metal or solid plastic; however, alternate materials may be substituted without departing from the scope of the present invention.

As depicted, frame 102 includes a plurality of frame floor apertures 132, which facilitate mounting frame 102 to an approximately horizontal surface upon which it rests. Such mounting may be performed using virtually any type of fastening method as known in the art including, but not limited to, screws, bolts, pins, keyhole slide-in mountings, etc.

In one aspect of the present invention, front brace 104 (FIG. 1) attaches to frame 102 by aligning at least one pair of front brace apertures 112 (FIG. 1), wherein each one of the pair of front brace apertures 112 (FIG. 1) is located on opposing front brace sides 114a and 114b (FIG. 1), with a pair of frame side apertures 108, wherein each one of the pair of frame side apertures is located on opposing frame sides 110 of frame 102. After these apertures are properly aligned, a retention mechanism such as retention mechanism 116a (FIG. 1) may be passed therethrough to couple front brace 104 (FIG. 1) to frame 102. In some embodiments of the present invention, retention mechanism 116a is a pin secured at one end via its head and secured on a second end via a hairpin 142 passing through retention mechanism bore 144; however, alternate retention mechanisms (e.g., bolts, rods, rivets, etc.) may be substituted without departing from the scope of the present invention. Furthermore, in embodiments of the present invention in which the longitudinal spacing of front brace apertures 112 (FIG. 1) is equivalent to the longitudinal spacing of frame side apertures 108, more than one retention mechanism 116 may be used for attachment of front brace 104 (FIG. 1) to frame 102. For example, as depicted in FIG. 1, two retention mechanisms 116a and 116b are incorporated. When a plurality of retention mechanisms 116 are used, such mechanisms may be identical or may vary without departing from the scope hereof. Although a minimum of two front brace apertures 112 (FIG. 1) are required to mount front brace 104 to frame 106 as discussed above, a greater quantity of apertures may be provided without departing from the scope of the present invention. Additional embodiments of the present invention are also envisioned in which front brace 104 is attached to frame 102 in a stationary manner such as via welding or the like.

Similarly, rear brace 106 (FIG. 1) attaches to frame 102 by aligning the longitudinal ends of rear brace coupling 118 (FIG. 1) with a pair of frame side apertures 108, wherein each one of the pair of frame side apertures is located on opposing frame sides 110 of frame 102. After rear brace coupling 118 (FIG. 1) and frame side apertures 108 are properly aligned, a retention mechanism such as retention mechanism 116c may be passed therethrough to couple rear brace 106 (FIG. 1) to frame 102 in a manner that allows rear brace 106 (FIG. 1) to pivot with respect to frame 102. In some embodiments of the present invention, retention mechanism 116c is a pin secured at one end via its head and secured on a second end via a hairpin 142 passing through retention mechanism bore 144; however, alternate retention mechanisms may be substituted without departing from the scope of the present invention.

Additionally, in embodiments of the present invention in which a quantity of six or more frame side apertures 108 are provided, the positions of front and/or rear braces 104 and 106, respectively, are adjustable along the length of frame 102. For example, in the embodiment of the present invention depicted in FIG. 1, a position of front brace 104 may be adjusted by simply removing retention mechanism(s) 116a and 116b, sliding front brace 104 to a desired position in which each one of the pair of front brace apertures 112 (FIG. 1) aligns with a pair of frame side apertures 108, and re-inserting the removed retention mechanism(s) 116a and/or 116b. The quantity of positions available for front brace 104 directly corresponds to the quantity of pairs of frame side apertures 108 provided in the typical vicinity of front brace 104. Furthermore, although not depicted, frame 102 may also include a plurality of frame apertures 108 in the vicinity of rear brace 106 such that it may be longitudinally adjustable in the same manner described herein for front brace 104. However, the scope of the present invention includes embodiments having both adjustable and non-adjustable front and rear braces. For example, it may be desirable to have adjustable front and/or rear braces that allow the vehicle support to be adjusted to accommodate varying wheel and/or tire sizes.

When utilized, stabilizer 124 (FIG. 1) may also be attached to frame 102 by aligning the longitudinal ends of stabilizer coupling 126 (FIG. 1) with a pair of frame side apertures 108, wherein each one of the pair of frame side apertures is located on opposing frame sides 110 of frame 102. After stabilizer coupling 124 (FIG. 1) and frame side apertures 108 are properly aligned, retention mechanism 116d may be passed therethrough to couple stabilizer 124 (FIG. 1) to frame 102. In some embodiments of the present invention, retention mechanism 116d is a pin secured at one end via its head and secured on a second end via a hairpin 142 passing through retention mechanism bore 144, however, alternate retention mechanisms may be substituted without departing from the scope of the present invention.

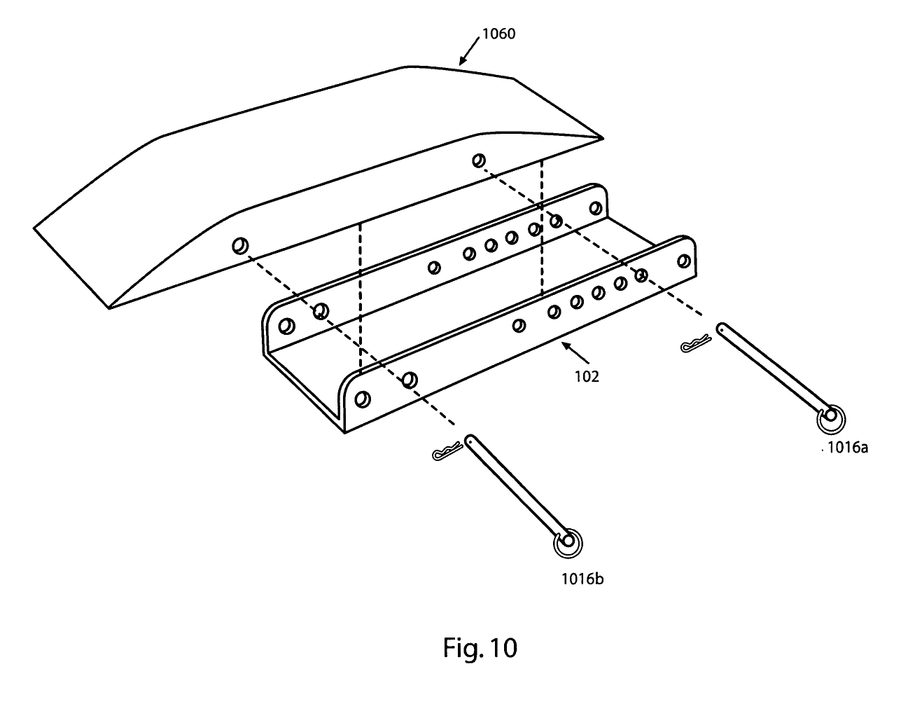

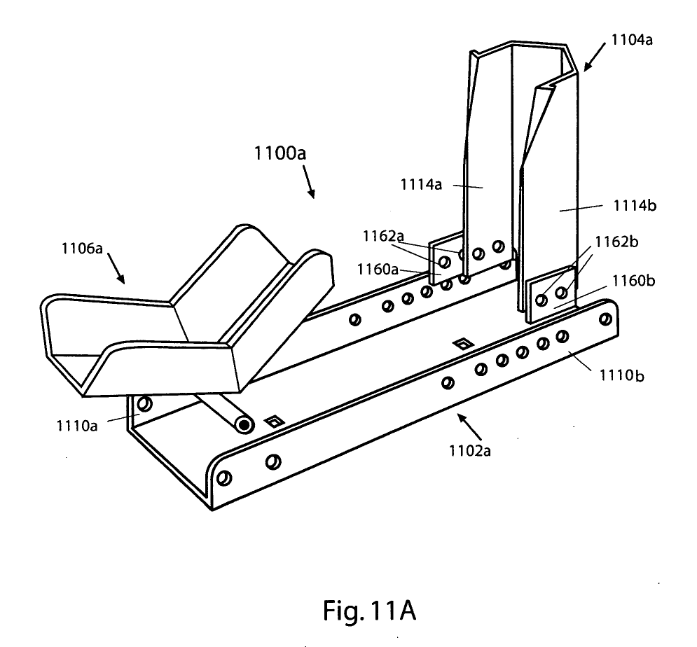

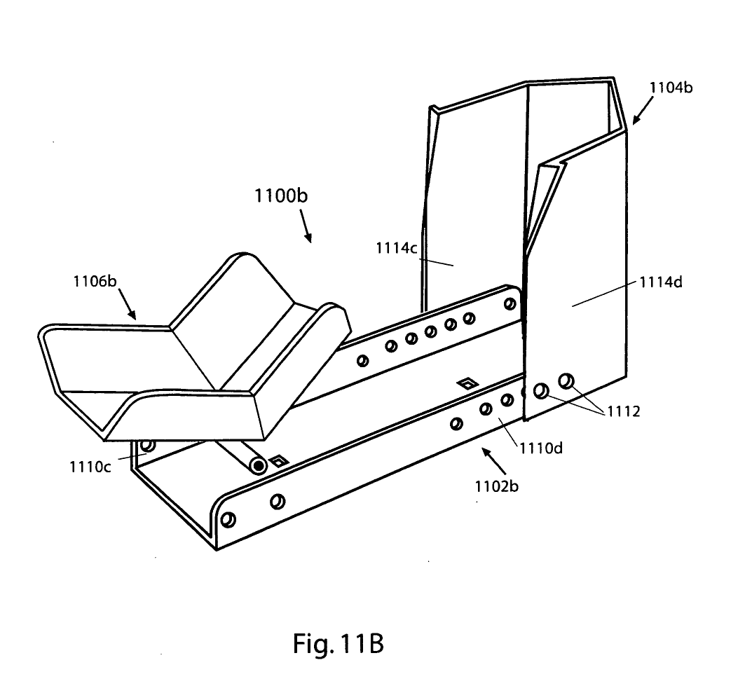

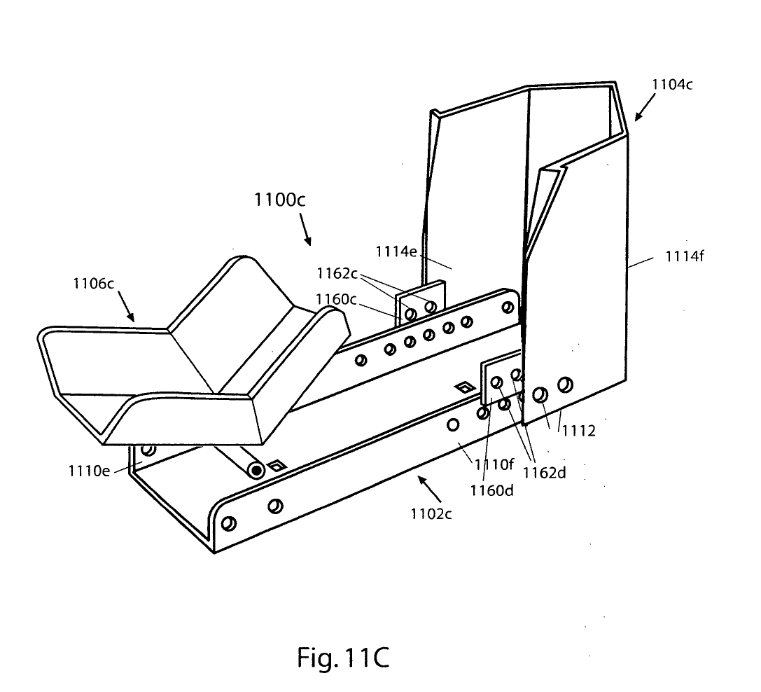

Although coupling of front and rear braces 104 and 106, respectively, and stabilizer 124 have been discussed above, other components (e.g., winches such as winch 850 (FIG. 8), frame covers such as frame cover 1060 (FIG. 10), spacers such as spacers 1160a and 1160b (FIG. 11A) and spacers 1160a and 1160b (FIG. 11C), etc.) may also be mounted in a similar fashion to frame 102 without departing from the scope of the present invention. To accommodate this, frame 102 may be equipped apertures in addition to those described in detail herein.

Turning now to FIG. 2B, depicted is frame 202a in accordance with an alternate embodiment of the present invention. Frame 202a includes frame floor 220a, frame side apertures 208a, frame sides 210a, frame flanges 222a, and frame flange apertures 224a. Frame floor 220a, frame side apertures 208a, and frame sides 210a are similar to frame floor 120, frame side apertures 108, and frame sides 110, respectively, as discussed above with respect to FIG. 1. However, frame 202a further includes frame flanges 222a, which include frame flange apertures 224a. Frame flange apertures 224a facilitate attachment of frame 202a to a surface including, without limitation, the floor of a trailer, a basement floor, etc. with one or more fastening mechanism that pass through frame flanges 222a. Passing of such mechanisms through frame flanges 222a rather than frame floor 220a prevents obstruction of the pathway created within frame sides 210a.

Similarly, referring now to FIG. 2C, depicted is frame 202b in accordance with another alternate embodiment of the present invention. Frame 202b includes frame floor 220b, frame side apertures 208b, frame sides 210b, and frame flanges 222b. Frame floor 220b, frame side apertures 208b, and frame sides 210b are similar to frame floor 120, frame side apertures 108, and frame sides 110, respectively, as discussed above with respect to FIG. 1. However, frame 202b further includes frame flanges 222b, which include frame flange apertures 224b. Frame flange apertures 224b facilitate attachment of frame 202b to a surface including, without limitation, the floor of a trailer, a basement floor, etc. with one or more fastening mechanism that pass through frame flanges 222b. Passing of such mechanisms through frame flanges 222b rather than frame floor 220b prevents obstruction of the pathway created within frame sides 210b.

Referring back to FIG. 1, in some aspects of the present invention such as that depicted in FIG. 1, front brace 104 is a V-shaped component of sufficient width to receive a front or rear wheel and/or tire of the vehicle to be supported by vehicle support 100. For example, as depicted in FIG. 3, a tire such as tire 336 will contact inwardly facing surfaces 334 of front brace nose 304. Such contact will aid in holding the tire, and therefore the vehicle, in a stationary and/or upright position as it provides lateral support while simultaneously resisting movement of the wheel and/or the tire in the direction of front brace nose 304.

Additionally, front brace 104 may optionally include front brace secondary apertures 146 for attachment of fastening mechanisms such as tie-down straps, ratchet straps, twine, bungee cables, etc. In one aspect of the present invention, such fastening mechanisms are incorporated to bias rear brace 106 toward front brace 104, thereby providing allowing vehicle support 100 to more securely hold the contained wheel and/or tire. However, such fastening mechanisms may be included for alternate purposes without departing from the scope of the present invention.

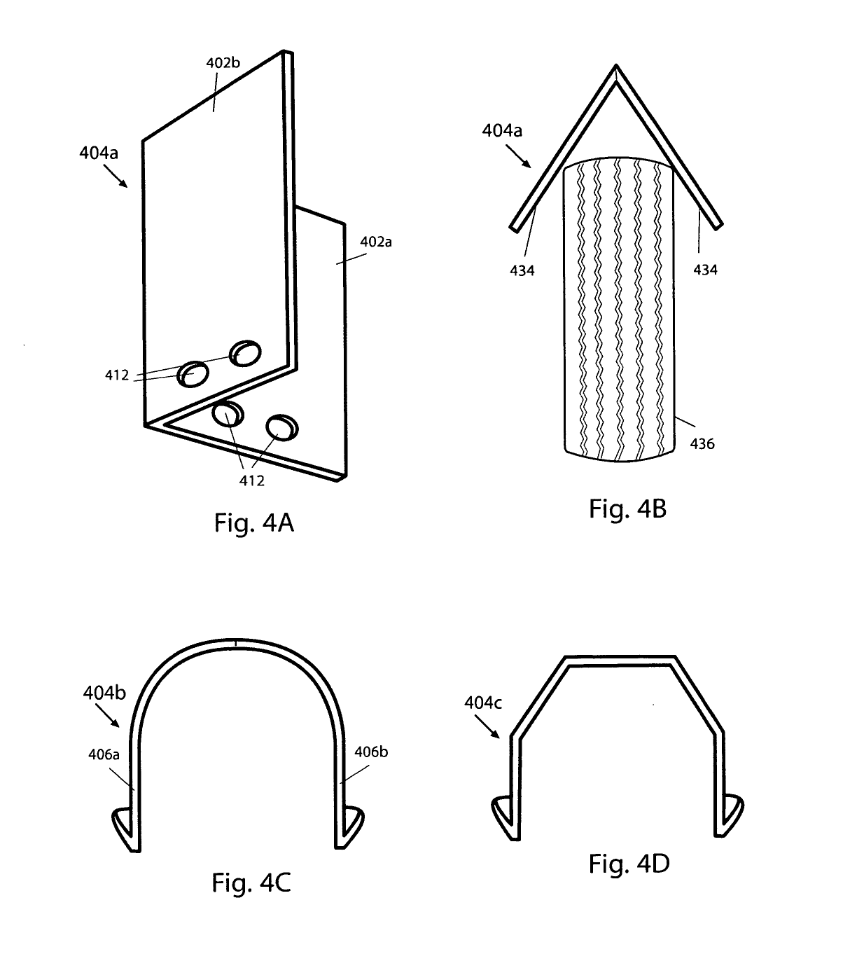

In its most simplistic form, as depicted in FIG. 4A, front brace 404a may be fabricated from a single approximately rectangular sheet of material by forming one latitudinal bend such that two front brace sides 402a and 402b are formed, wherein such front brace sides are positioned in a V configuration relative to each other as depicted in FIG. 4A. Front brace 404a may also include front brace apertures 412, which allow front brace 404a to be attached to a frame such as frame 102 (FIG. 1) or the like as described above with respect to FIG. 2A. However, alternate embodiments are envisioned in which multiple pieces are attached together via welding or the like. Or, in other embodiments, the front brace may be formed as a single piece via injection molding, aluminum extrusion, or the like. However, such methods of manufacturing front brace 104 are exemplary only and other methods may be substituted without departing from the scope of the present invention. Additionally, although FIG. 4A depicts front brace apertures 412 for mounting front brace 404a to a frame, alternate mounting methods and/or components may be substituted without departing from the scope of the present invention.

Turning now to FIG. 4B, when a user wishes to support a vehicle via a vehicle support equipped with a simplistic front brace such as front brace 404a, either the front or rear wheel of the vehicle is rolled over the rear brace of the vehicle support such as rear brace 106 (FIG. 1) of vehicle support 100 (FIG. 1) and through the longitudinal channel formed by the frame until the tire of the wheel, such as tire 436 contacts inwardly facing surfaces 434 of front brace 404a. At the point at which tire 436 contacts front brace 404a, the force of the weight of the tire and associated wheel causes the rear brace such as rear brace 106 (FIG. 1) to pivot to a position in which the rear brace and front brace 404a retain the wheel, and therefore the vehicle, in a fixed, upright position.

Turning next to FIG. 4C, depicted is another simplistic form of a front brace (i.e., front brace 404b) in which the nose is rounded. Front brace 404b may be fabricated from a single approximately rectangular sheet of material by rolling it via a roller and/or forming one latitudinal bend such that two front brace sides 406a and 406b are formed, wherein such front brace sides are positioned in a V or U configuration relative to each other. Front brace 404b may also include front brace apertures such as front brace apertures 412 (FIG. 4A), which allow front brace 404b to be attached to a frame such as frame 102 (FIG. 1) or the like. However, alternate embodiments are envisioned in which multiple pieces are attached together via welding or the like. Or, in other embodiments, front brace 404b may be formed as a single piece via injection molding, aluminum extrusion, or the like. However, such methods of manufacturing front brace 404b are exemplary only and other methods may be substituted without departing from the scope of the present invention. Additionally, although front brace 404b is described herein with front brace apertures such as front brace apertures 412 for mounting front brace 404b to a frame, alternate mounting methods and/or components may be substituted without departing from the scope of the present invention.

Referring back to FIG. 1, in a more complex form, front brace 104 may be fabricated from a single sheet of material by forming three or five latitudinal bends. In addition to the single bend described above with respect to FIG. 4A, a second and third bend may be required to form front brace primary flanges 114a and 114b. Front brace primary flanges 114 facilitate a secure coupling of front brace 104 to a frame such as frame 102 as the entire width of the outwardly facing bottommost edges of front brace primary flanges 114 may be placed in contact with the inwardly facing surfaces of frame sides such as frame sides 110. Also, in embodiments of the front brace having front brace primary flanges 114, front brace apertures 112 may be included in such flanges to provide a more secure attachment of front brace 104 to frame 102. Also, optionally, fourth and fifth bends may be performed to form front brace secondary flanges 140a and 140b. Front brace secondary flanges 140 transform the thin, potentially sharp edges (e.g., in a scenario in which front brace 104 is fabricated from sheet metal) of front brace primary flanges 114 into blunt surfaces to minimize the possibility of such edges slicing, cutting, or otherwise damaging a tire upon entry of same into front brace 104. Furthermore, front brace secondary flanges 140 reduce the possibility that a tire entering front brace 104 will get caught up on the narrow edges of such flanges.

Although embodiments of the front braces of the present invention having one, three, and five bends have been discussed, additional bends may be added to provide additional features not discussed herein or for other purposes without departing from the scope of the present invention. For example, a sixth bend may be added to the nose of front brace 104 to create a brace such as brace 404c, as depicted in FIG. 4D. Such bend creates a blunt nose that adds lateral rigidity to the front brace. Also, in lieu of the bends discussed above, the front brace may be created from multiple pieces via welding or the like. Or, in other embodiments, front brace 104 may be formed as a single piece via injection molding, aluminum extrusion, or the like. However, such methods of manufacturing front brace 104 are exemplary only and other methods may be substituted without departing from the scope of the present invention. Additionally, although FIG. 1 depicts front brace apertures 108 for mounting front brace 104 to a frame, alternate mounting methods and/or components may be substituted without departing from the scope of the present invention.

Vehicle support 100 also includes rear brace 106. In some aspects of the present invention, rear brace 106 includes two symmetrical sections, namely first rear brace section 107a and second rear brace section 107b, which each extend from a latitudinal pivot point such as rear brace coupling 118. Upon loading the wheel of a vehicle into vehicle support 100, first rear brace section 107a is first depressed by the force of the weight of the wheel as it is rolled into the longitudinal path of frame 102 such that the outwardly facing surface of first rear brace section 107a contacts the horizontal surface adjacent to the beginning of frame 102's longitudinal path. As the wheel rolls through rear brace 106, the force of the weight of the wheel moves with the motion of the wheel eventually depressing second rear brace section 107b such that its outwardly facing surface, when properly adjusted, pivots to a position in which its outwardly facing surface remains slightly elevated above the approximately horizontal surface upon which vehicle support 100 is mounted and/or frame floor 120. As second rear brace section 107b is depressed, rear brace 106 pivots with respect to rear brace coupling 118, thereby causing first rear brace section 107a to rotate clockwise such that its inwardly facing surface contacts the rear-facing portion of the wheel (or the tire thereof). The force of the weight of the wheel, as well as the force of the weight of the respective vehicle, holds rear brace 106 in this final position until it is manually rolled backwards such that it exits the longitudinal path of frame 102. In such respects, rear frame 106 is self-locking. Although rear frame 106 includes symmetrical first and second rear brace sections 107a and 107b, respectively, asymmetrical sections may be substituted without departing from the scope of the present invention. For example, asymmetrical sections may be beneficial if a first rear brace section such as first rear brace section 107a must be shortened to ensure that it does not interfere with a low fender or low fairing of the wheeled vehicle to be supported by the vehicle support. In this scenario, it may be desirable to include a longer second rear brace section such as section rear brace section 107b to provide greater contact with the contained wheel, which will result in a more stable grip of same. However, this is only one example of the benefits of an asymmetrical rear brace. Such a brace may be incorporated for other purposes without departing from the scope of the present invention.

Additionally, rear brace 106 may optionally include rear brace secondary apertures 148 for attachment of fastening mechanisms such as tie-down straps, ratchet straps, twine, bungee cables, etc. In one aspect of the present invention, such fastening mechanisms are incorporated to bias rear brace 106 toward front brace 104, thereby providing allowing vehicle support 100 to more securely hold the contained wheel and/or tire. However, such fastening mechanisms may be included for alternate purposes without departing from the scope of the present invention.

In one aspect of the present invention, frame 102 does not extend beyond the pivot point of rear brace 102. This configuration allows the outwardly facing surface of first rear brace section 107a to rest directly upon the surface upon which frame 102 rests or is mounted. Such configuration facilitates loading of a vehicle into vehicle support 100 as the vehicle does not require lifting to the height at which frame 102 is mounted. However, alternate embodiments of the present invention are envisioned in which the outwardly facing surface of first rear brace section 107a rest directly upon frame 102, which extends beyond the length depicted in FIG. 1 such that it lies underneath first rear brace section 107a.

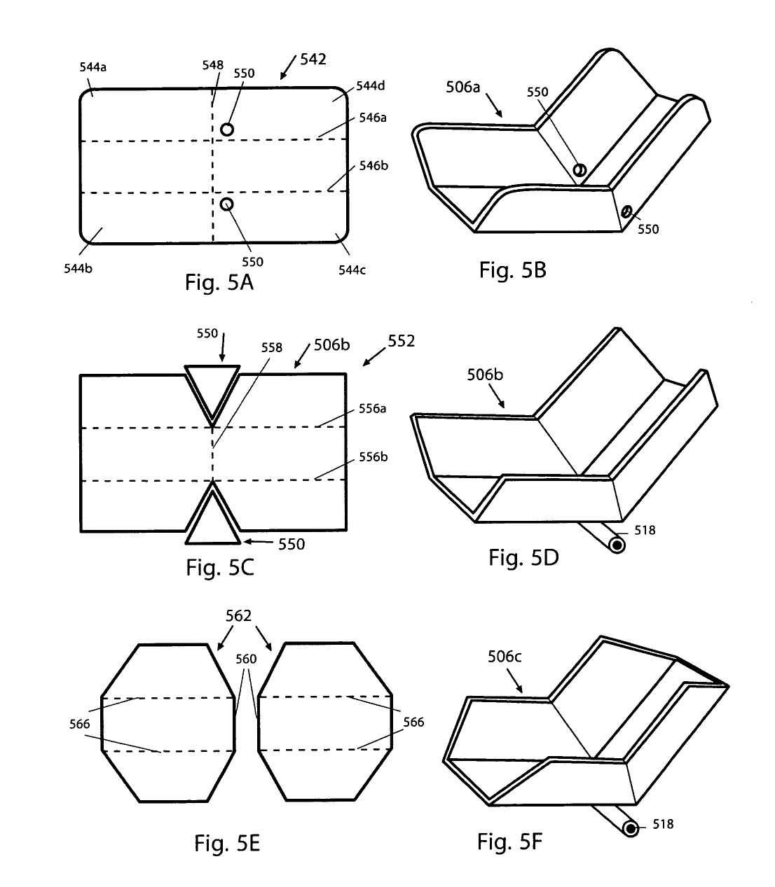

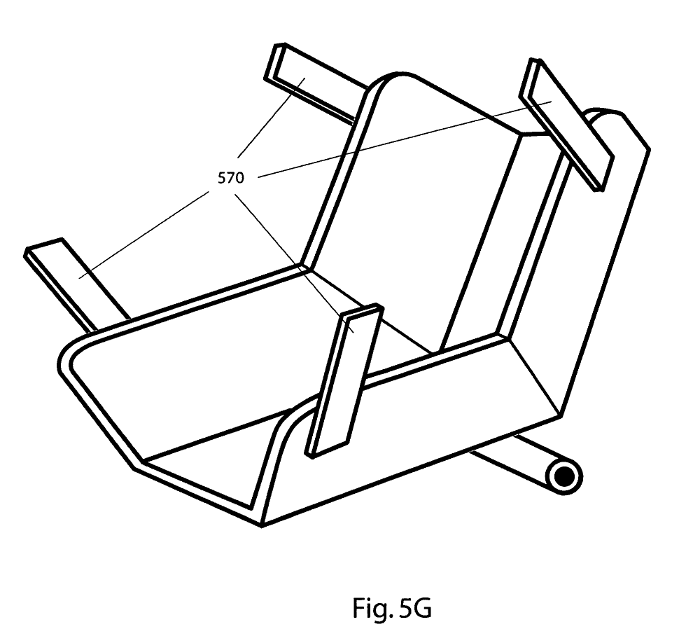

Turning next to FIG. 5A, in a simplistic embodiment of the present invention, rear brace 506a (FIG. 5B) may be fabricated from a single approximately rectangular sheet of material such as sheet 542 by first shrinking, cutting, or otherwise reducing corners 544 as depicted in FIG. 5A. Thereafter, two bends are formed along longitudinal bend lines 546 such that a U-shaped channel is formed. Next, a slight third bend is formed along latitudinal bend line 548 such that rear brace 506a, as depicted in FIG. 5B is formed. Then, optionally, rear brace apertures 550 may be bored through rear brace 506a such that rear brace 506a may be mounted to a frame such as frame 102 by placing rear brace 506a within frame 102 such that rear brace apertures 550 align with frame side apertures 108. This allows retention mechanism(s) such as retention mechanism(s) 116 (FIG. 1) to be passed therethrough as discussed above with respect to FIG. 1. The concave, inverted V-shaped structure of rear brace 506a allows it to pivot with respect to such retention mechanism similar to the pivoting action provided by rear brace coupling 118, as discussed in greater detail above.

Turning next to FIG. 5C, in another simplistic embodiment of the present invention, rear brace 506b may be fabricated from a single approximately rectangular sheet of material such as sheet 552 by first notching or otherwise cutting triangular segments 550 from the midsections of sheet 552. Thereafter, two bends are formed along longitudinal bend lines 556 such that a U-shaped channel is formed. Next, a slight third bend is formed along latitudinal bend line 558 such that rear brace 506b, as depicted in FIG. 5D is formed. Then, optionally, rear brace coupling 518 may be attached to a downwardly facing surface of rear brace 506b to allow it to be coupled to a frame such as frame 102 in the same manner as described above with respect to rear brace 106 and rear brace coupling 118. Rear brace coupling 518 allows rear brace 506b to pivot with respect to a frame as described in greater detail herein.

Referring next to FIGS. 5E and 5F, a rear brace such as rear brace 506c may also be formed by bending two individual sections and then welding two or more sections together at the desired angle relative to each other. For example, in the embodiment of the present invention depicted in FIGS. 5E and 5F, octagonal sections 562 are bent along longitudinal bend lines 566 such that two individual U-shaped channels are formed. Then, octagonal sections 562 are welded together along edges 560. Thereafter, rear brace coupling 518 is attached to a downwardly facing surface of rear brace 506c to allow it to be coupled to a frame such as frame 102 in the same manner as described above with respect to rear brace 106 and rear brace coupling 118. Rear brace coupling 518 allows rear brace 506b to pivot with respect to a frame as described in greater detail herein.

Although FIGS. 5A-5D disclose embodiments in which single sheets are bent along a latitudinal edge, such embodiments may also be formed by fabricating independent sections having the configuration of each half of the single sheet and welding them together at the desired angle relative to each other. Similarly, although FIGS. 5E-5F depict an embodiment in which two orthogonal sections are welded together, such sections may be formed from a single piece and may also be bent along a latitudinal bend line to create the desired rear brace. Additionally, the embodiments depicted in FIGS. 5A-5F are exemplary only and alternate designs and/or configurations for the individual sections of the rear brace as well as varying methods of configuring such sections relative to each other (e.g., welding, bending, deep draw stamping, etc.) may be substituted without departing from the scope of the present invention. Or, in other embodiments, the rear brace may be formed as a single piece via injection molding, aluminum extrusion, or the like. However, such methods of manufacturing the rear brace are exemplary only and other methods may be substituted without departing from the scope of the present invention.

Furthermore, although each rear brace 506a-506c includes rear brace apertures or a rear brace coupling, such items may be used interchangeably without departing from the scope of the present invention. That is, in embodiments in which rear brace apertures are depicted, a rear brace coupling may be substituted and vice versa. Also, other pivoting mechanisms other than rear brace apertures and rear brace couplings may be substituted without departing from the scope of the present invention.

Referring next to FIG. 5G, embodiments of the present invention are also envisioned in which a rear brace such as rear brace 506d includes extensions 570 extending from one or both ends of the rear brace. Such extensions provide additional support of the wheel or tire contained therein, or the vehicle supported by the vehicle support, by preventing lateral movement of the wheel, as such extensions are positioned to physically contact the wheel sidewalls. Although FIG. 5G depicts extensions 570 attached to a rear brace such as rear brace 106 (FIG. 1), such extensions may be used with any configuration or embodiment of a rear brace without departing from the scope of the present invention.

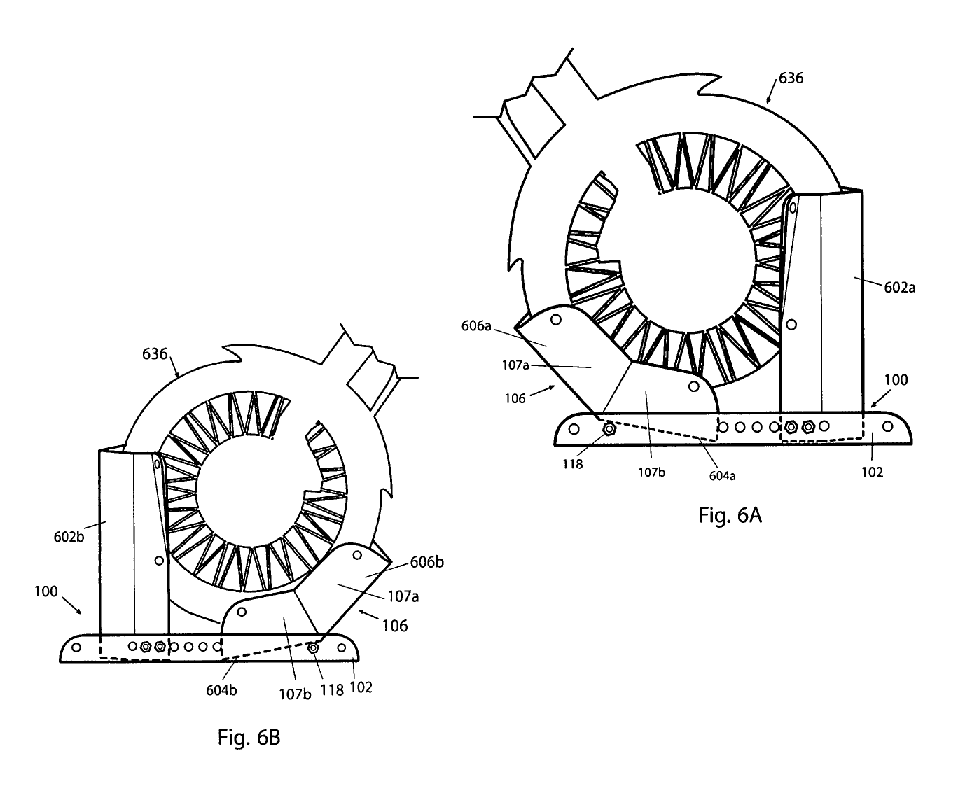

Referring now to FIGS. 6A and 6B, when a wheel is loaded into vehicle support 100 as described in the preceding paragraph, vehicle support 100 engages the perimeter of the tire of the loaded wheel at three separated pairs of contact points (i.e., 602a and 602b, 604a and 604b, and 606a and 606b) to allow it to adequately hold the vehicle in a stationary and/or upright position via contact with a single wheel of the vehicle. The primary function of contact points 602 is to prevent the wheel, or tire thereof, from rolling out of contact with contact points 604 and 606. Furthermore, in addition to preventing rolling of the wheel, the V-shaped configuration of front brace 104 allows its contact points 602 to also prevent lateral movement of the wheel, as these contact points may be in physical contact with the tire and/or wheel sidewalls. Similarly, the sloped configuration of first and second rear brace sections 107a and 107b also prevents lateral movement of the wheel at contact points 604a and 606a and/or longitudinal movement of the wheel between contact points 604a and 606a.

Additionally, as discussed above, upon loading wheel 636 of a vehicle into vehicle support 100, first rear brace section 107a is first depressed by the force of the weight of the wheel as it is rolled into the longitudinal path of frame 102 such that the outwardly facing surface of first rear brace section 107a contacts the horizontal surface adjacent to the beginning of the frame's longitudinal path. As the wheel rolls through rear brace 106, the force of the weight of the wheel moves with the motion of the wheel eventually depressing second rear brace section 107b such that its outwardly facing surface, when properly adjusted, pivots to a position in which its outwardly facing surface remains slightly elevated above frame floor 120 (FIG. 1). As wheel 636 comes into contact with contact points 604a and 604b, the gravitational force applied to such contact points by wheel 636 causes first rear brace section 107a to lift via the pivoting action of rear brace coupling 118, thereby clamping wheel 636 and forcing it toward contact points 602 by redirecting the gravitational force applied to contact points 604 to a forward moving force applied to contact points 606.

The redirection of the gravitational force exerted upon contact points 604 is facilitated by the pivoting action of rear brace coupling 118. In some aspects of the present invention, rear brace coupling 118, or a similar pivoting mechanism, is located proximal to contact points 606 to provide greater redirection of the gravitational force in the forward direction (i.e., towards contact points 602). However, other locations for the pivoting mechanism(s) may be substituted without departing from the scope of the present invention. Similarly, in some embodiments of the present invention, rear brace 106 is weighted such that the outwardly facing surface of first rear brace section 107a will lie upon the approximately horizontal surface upon which vehicle support 100 rests whenever a wheel is not loaded in such support. Such weighting facilitates the initial loading of the wheel into vehicle support 100 by eliminating the need for positioning of the rear brace, lifting of the vehicle, etc. However, alternate embodiments having varying weighting may be substituted without departing from the scope of the present invention.

Referring back to FIG. 1, stabilizer 124 may be optionally used in conjunction with vehicle support 100 to provide additional stability to same, particularly when vehicle support 100 is not otherwise secured to the approximately horizontal surface upon which it rests. In the embodiment depicted in FIG. 1, stabilizer 124 includes stabilizer coupling 126, stabilizer arm 128, and stabilizer feet 130. Stabilizer coupling 126 is a tubular piece that facilitates coupling of stabilizer 124 to frame 102 as discussed in greater detail above with respect to FIG. 1 and the coupling of rear brace 106 to frame 102. However, any stabilizer coupling that facilitates attachment of stabilizer 124 to frame 102 (e.g., flanges extending from the downwardly facing surface of stabilizer arm 128 having apertures that correspond to frame side apertures 108, wherein such flanges may be located internal or external to sides 110 of frame 102) may be substituted without departing from the scope of the present invention.

Stabilizer arm 128 may include virtually any length of rigid material having a length greater than the width of frame 102 such that when stabilizer 124 is coupled to frame 102, stabilizer arm 128 extends latitudinally in one or both directions therefrom. Stabilizer arm 128 may optionally be equipped with a plurality of stabilizer feet 130 to provide contact between stabilizer 128 and the approximately horizontal surface upon which frame 102 rests. In some aspects of the present invention, the downwardly facing surfaces of stabilizer feet 130 are equipped with non-skid pads to minimize movement of vehicle support 100 during loading of a vehicle. Coupling of stabilizer 124 to frame 102 minimizes the possibility that frame 102 will rotate, skid, or otherwise move, which movement would increase the difficulty of rolling the wheel of the vehicle being loaded over rear brace 106. However, in addition to adding stabilizer 124 to frame 102, the vehicle may also be further stabilized via the use of tie-down straps or the like, which may be secured to vehicle support 100, for example, through attachment mechanisms 134. Such attachment mechanisms may be in the form of a loop or any other configuration that allows a strap or any other fastening mechanism to be passed therethrough or attached thereto.

Referring next to FIGS. 7A and 7B, the vehicle support of the present invention also facilitates loading of a plurality of vehicles in an aligned manner. In some such scenarios, the plurality of vehicles may be loaded onto a trailer such as trailer 742 for transportation, storage, or the like. Such loading is facilitated by first installing a plurality of frames such as frames 702a-702d of vehicle supports 700a-700d upon a surface such as trailer surface 744 of trailer 742. Once the frames have been installed, the other components (e.g., front brace, rear brace, stabilizer, etc.) of the forward vehicle supports (i.e., vehicle supports 700b and 700c) may be installed, whereas the other components of the rear vehicle supports (i.e., vehicle supports 700a and 700d) are not installed. This allows vehicles to be loaded into the forward vehicle supports without removing the rear vehicle support frames (i.e., frames 702a and 702d) since the vehicle may be simply wheeled, driven, or otherwise moved through the rear vehicle support frame without obstruction and thereafter loaded into the forward vehicle support as depicted in FIG. 7A with respect to frame 702a and vehicle support 700b. After a vehicle has been loaded into a front vehicle support, the components of any vehicle supports aligned behind such loaded vehicle support may then be installed. Such installation allows a vehicle to be loaded into the rear vehicle support directly behind the vehicle loaded into the front vehicle support. Although FIG. 7B depicts loading of vehicles such that two vehicles are aligned, any quantity of vehicles may be loaded in such alignment without departing from the scope of the present invention.

Furthermore, unloading of a plurality of vehicles is also facilitated by the systems and methods of the present invention since the frames of any one or more rear vehicle supports do not need to be removed from the surface to accommodate removal of vehicles from any vehicle supports aligned in front of such rear vehicle supports. For example, in the embodiment depicted in FIG. 7B, after removal of any vehicle loaded into vehicle support 700a, the components of vehicle support 700a may be removed from frame 702a, which remains securely fastened to trailer surface 744. Thereafter, the vehicle loaded into vehicle support 700b may be removed from such support and may be simply rolled through frame 702a for unloading from trailer surface 744. That is, the systems and methods of the present invention allow a plurality of vehicle supports to be permanently installed on a surface without obstructing the loading of a plurality of vehicles.

Turning now to FIGS. 8A and 8B, depicted are exploded views and perspective views of the attachment of a winch such as winch 850 to a frame 802, which is similar to frame 102 as described in greater detail above with respect to FIG. 2A, in accordance with the present invention. As depicted, prior to attachment of winch 850, all of the components (e.g., front brace, rear brace, accessories, etc.) of frame 802 have been removed. Winch 850 may be any type of winch known in the art including, but not limited to, an electric winch, a hand winch, etc. Winch 850 may be installed in the same manner as front and rear braces 104 and 106, respectively, as described above in greater detail with respect to FIG. 1. That is, first winch 850 is placed atop frame 802 such that winch apertures 812 align with frame apertures 808 as depicted in the exploded view of FIG. 8A. Thereafter, as depicted in the perspective view of FIG. 8B, retention mechanisms 816, which may be similar to retention mechanisms 116 as discussed in greater detail above with respect to FIG. 1, may be passed through frame apertures 808. Thereafter, hairpins 842 may be passed through retention mechanism bores 844 to secure winch 850 to frame 802. Or alternate installation and/or fastening methods may be substituted without departing from the scope of the present invention. The ability to remove all components from the frame allows such a winch to be installed. This feature may be particularly useful when loading a vehicle or pulling a disabled vehicle aboard a horizontal surface upon which frame 802 is mounted or rests such as the bed of a trailer. Once the wheel of the vehicle has been pulled into frame 802, the other components of the vehicle support (e.g., front brace, rear brace, etc.) may be reinstalled to hold the loaded and/or disabled vehicle in a stationary and/or upright position.

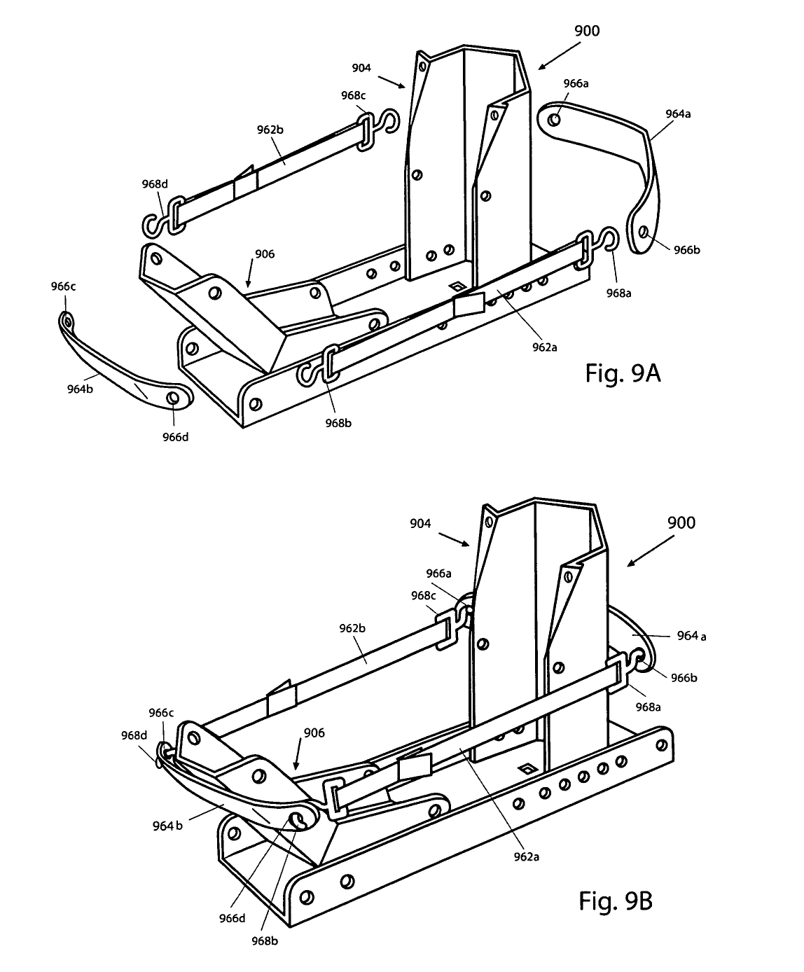

Referring now to FIG. 9A, depicted is an alternate embodiment of the present invention for use with ratchet straps. In the embodiment of the present invention depicted in FIG. 9A, front and rear brace 904 and 906, respectively, are similar to front brace 104 and rear brace 106, respectively, as described in greater detail above with respect to FIG. 1 except that front and rear braces 904 and 906, respectively, are equipped with ratchet strap braces 964. Ratchet strap braces 964 may be permanently or removably affixed to front and rear braces 904 and 906, respectively. Such braces may be permanently affixed via welding or the like. Or such braces may be fabricated as an integral component of front and rear braces 904 and 906, respectively, by using methods such as injection molding, aluminum extrusion, or the like. Or such braces may be removably affixed via fastening mechanisms such as screws, bolts, pins, keyhole slide-in mountings, slide tabs, accessible recessed threaded fasteners, etc.

Ratchet straps 962 are conventional ratchet straps as are known in the art. In one aspect of the present invention, two ratchet straps 962 are used in conjunction with vehicle support 900. In one such use, hooked end 968a of ratchet strap 962a is passed through ratchet strap brace aperture 966b of ratchet strap brace 964a. Thereafter, hooked end 968b of ratchet strap 962a is passed through ratchet strap brace aperture 966d of ratchet strap brace 964b. Next, hooked end 968c of ratchet strap 962b is passed through ratchet strap brace aperture 966a of ratchet strap brace 964a. Thereafter, hooked end 968d of ratchet strap 962b is passed through ratchet strap brace aperture 966c of ratchet strap brace 964b. Then, both ratchet straps 962 are tightened via their inherent ratcheting mechanism as is known in the art. Such tightening draws rear brace 906 toward front brace 904 as depicted in FIG. 9B, thereby securing a tighter hold on the contained vehicle wheel. Although the foregoing describes one method of attaching ratchet straps 962 to vehicle support 900, varying steps may be substituted and/or the order of such steps may be varied without departing from the scope of the present invention. Also, in one aspect of the present invention such as that depicted in FIG. 9A, ratchet strap brace apertures 966 are separated by a sufficient distance to prevent interference of ratchet strap(s) 962 and/or ratchet strap braces 964 with the tire and/or wheel contained within vehicle support 900, as well as any suspension or other mechanisms attached to the tire and/or wheel.

Turning next to FIG. 10, depicted is an exploded view of cover 1060 for covering a vehicle support frame such as frame 102 as described in greater detail above with respect to FIG. 1 in accordance with one embodiment of the present invention. Such covers may be used to protect a frame while it is not in use. For example, such covers may be used in conjunction with frames installed on the floor of a trailer to prevent damage when objects other than vehicles are loaded atop the frames. In one aspect of the present invention such as that depicted in FIG. 10, cover 1060 is attached to frame 102 via retention mechanisms 1016, which are similar to retention mechanisms 116 as described in greater detail above with respect to FIG. 1. However, other methods of attaching cover 1060 to frame 102 may be substituted without departing from the scope of the present invention.

Referring now to FIG. 11A, depicted is vehicle support 1100a for use with a vehicle having a narrow tire and/or wheel in accordance with one embodiment of the present invention. Vehicle support 1100a includes frame 1102a, front brace 1104a, and rear brace 1106a. Frame 1102a, front brace 1104a, and rear brace 1106a are similar to frame 102, front brace 104, and rear brace 106, respectively, as discussed in greater detail above with respect to FIG. 1, except that there is less distance between the inwardly facing surfaces of the sides of front and rear braces 1104a and 1106a, respectively, such that they may accommodate a narrower tire. To accommodate the narrower width of front brace 1104a, spacers 1160 are placed between the bottommost outwardly facing surfaces of front brace sides 1114a and 1114b and the inwardly facing surfaces of frame sides 1110a. In one aspect of the present invention, spacers 1160 include spacer apertures 1162, which allow spacers 1160 to be mounted to frame 1102a in the same manner in which front brace 104 is mounted to frame 102 as discussed in greater detail above with respect to FIG. 1.

Spacers 1160 may have varying widths to accommodate varying widths of front braces 1104a. That is, in some embodiments of the present invention, spacers 1160 will be sized to snugly fit between the bottommost outwardly facing surfaces of front brace sides 1114a and 1114b and the inwardly facing surfaces of frame sides 1110a. Therefore, as the width of front brace 1104a decreases, the width of spacers 1160 increases. However, alternate embodiments of the present invention are envisioned in which spacers 1160 do not occupy the entire space located between the bottommost outwardly facing surfaces of front brace sides 1114a and 1114b and the inwardly facing surfaces of frame sides 1110a.

Turning next to FIG. 11B, depicted is a vehicle support 1100b for use with a vehicle having a wide tire and/or wheel in accordance with one embodiment of the present invention. Vehicle support 1100b includes frame 1102b, front brace 1104b, and rear brace 1106b, which are similar to frame 102, front brace 104, and rear brace 106, respectively, as discussed in greater detail above with respect to FIG. 1, except that there is a greater distance between the inwardly facing surfaces of the sides of front and rear braces 1104b and 1106b, respectively, such that they may accommodate a wider tire. To accommodate the wider width of front brace 1104b, the bottommost inwardly facing surfaces of front brace sides 1114c and 1114d are located adjacent to the outwardly facing surfaces of frame sides 1110c and 1110d, respectively, such that front brace apertures 1112 align with corresponding apertures located in frame 1102b. This allows front brace 1104 to be mounted to frame 1102 in the same manner in which front brace 104 is mounted to frame 102 as discussed in greater detail above with respect to FIG. 1 except that front brace 1104 is in contact with the outwardly facing surfaces of frame 1102 rather than the inwardly facing surfaces of same.

Referring next to FIG. 11C, depicted is vehicle support 1100c for use with a vehicle having a wider tire and/or wheel in accordance with one embodiment of the present invention. Vehicle support 1100c includes frame 1102c, front brace 1104c, and rear brace 1106c. Frame 1102c, front brace 1104c, and rear brace 1106c are similar to frame 102, front brace 104, and rear brace 106, respectively, as discussed in greater detail above with respect to FIG. 1, except that there is a greater distance between the inwardly facing surfaces of the sides of front and rear braces 1104c and 1106c, respectively, such that they may accommodate a wider tire. To accommodate the wider width of front brace 1104c, spacers 1160 are placed between the bottommost inwardly facing surfaces of front brace sides 1114e and 1114f and the outwardly facing surfaces of frame sides 1110e and 1110f. In one aspect of the present invention, spacers 1160c and 1160d include spacer apertures 1162c and 1162d, respectively, which allow spacers 1160 to be mounted to frame 1102c in the same manner in which front brace 104 is mounted to frame 102 as discussed in greater detail above with respect to FIG. 1.

Spacers 1160 may have varying widths to accommodate varying widths of front braces 1104c. That is, in some embodiments of the present invention, spacers 1160 will be sized to snugly fit between the bottommost inwardly facing surfaces of front brace sides 1114e and 1114f and the outwardly facing surfaces of frame sides 1110e and 1110f, respectively. Therefore, as the width of front brace 1104c decreases, the width of spacers 1160 increases. However, alternate embodiments of the present invention are envisioned in which spacers 1160 do not occupy the entire space located between the bottommost inwardly facing surfaces of front brace sides 1114e and 1114f and the outwardly facing surfaces of frame sides 1110e and 1110f, respectively.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A wheeled vehicle support comprising:
a frame;
a front brace coupled to said frame; and
a rear brace coupled to said frame;
wherein said support supports a wheeled vehicle in at least one of the group consisting of a stationary position, an upright position, and combinations thereof; and
wherein a position of said front brace is longitudinally adjustable along said frame.

2. A support according to claim 1 further comprising:
a stabilizer for supporting said support in a free standing state.

3. A support according to claim 1, wherein said support allows loading of at least one of the group consisting of a front wheel of said wheeled vehicle and a rear wheel of said wheeled vehicle.

4. A support according to claim 1, wherein said rear brace pivots with respect to said frame as a wheel is rolled through said rear brace due to the force exerted upon said rear brace.

5. A support according to claim 1, wherein said rear brace is weighted to pivot in a direction away from said frame and said front brace whenever said rear brace is empty to facilitate loading of a wheel into said rear brace.

6. A support according to claim 1, wherein said frame is configured to allow an outwardly facing surface of said rear brace to rest upon at least one of the group consisting of a horizontal surface upon which said support rests, a floor of said frame, and combinations thereof prior to loading of a wheel into said rear brace.

7. A support according to claim 1, wherein said frame is a rectangular sheet of metal having at least two bends.

8. A support according to claim 7, wherein said frame includes an unobstructed pathway through a centerline of said frame.

9. A support according to claim 1, further comprising:
at least one retention mechanism for coupling at least one of the group consisting of said front brace, said rear brace, and at least one accessory to said frame;
wherein said frame includes at least two apertures for receiving said at least one retention mechanism.

10. A support according to claim 9, wherein said at least one accessory includes at least one of the group consisting of a stabilizer, a cover, a winch, a spacer, and combinations thereof.

11. A support according to claim 9, wherein said retention mechanism is at least one of the group consisting of a headed pin and hairpin, a bolt, a rivet, a rod, and combinations thereof.

12. A support according to claim 1, wherein said frame includes at least one flange.

13. A support according to claim 1, wherein said front brace is a rectangular sheet of metal having at least one bend.

14. A support according to claim 1, wherein said front brace includes at least one of the group consisting of a rounded nose, a blunt nose, and combinations thereof.

15. A support according to claim 1, wherein said front brace is at least one of the group consisting of U-shaped, V-shaped, and combinations thereof.

16. A support according to claim 1, wherein said front brace includes at least one of the group consisting of a primary flange, a secondary flange, and combinations thereof.

17. A support according to claim 1, wherein said rear brace includes at least one of the group consisting of a coupling, an extension, and combinations thereof.

18. A support according to claim 1 further comprising:
at least one spacer for mounting of at least one of the group consisting of a wide front brace and a narrow front brace to said frame.

19. A support according to claim 1, wherein at least one of the group consisting of said front brace, said rear brace, and combinations thereof is sized to accommodate at least one of the group consisting of wide wheels, narrow wheels, wide tires, narrow tires, and combinations thereof.

20. A support according to claim 1, wherein at least one of the group consisting of said front brace, said rear brace, and combinations thereof are removably coupled to said frame.

21. A support according to claim 1, wherein said frame provides an unobstructed pathway for one or more wheels of said wheeled vehicle whenever said front brace and said rear brace are removed from said frame.

22. A support according to claim 1, wherein a position of said rear brace is longitudinally adjustable along said frame.

23. A support according to claim 1, wherein any one of said front brace and said rear brace may be coupled to either one of a first end of said frame and a second end of said frame.

24. A support according to claim 1, wherein said front brace and said rear brace are at least one of the group consisting of interchangeable, reversible, and combinations thereof.

25. A wheeled vehicle support comprising:
a frame;
a front brace removably coupled to said frame; and
a rear brace removably coupled to said frame;
wherein said support supports a wheeled vehicle in at least one of the group consisting of a stationary position, an upright position, and combinations thereof; and
wherein said frame provides an unobstructed pathway for one or more wheels of said wheeled vehicle whenever said front brace and said rear brace are removed from said frame.

26. A support according to claim 20 further comprising:
at least one frame cover, said frame cover removably attachable to said frame;
wherein said frame cover protects said frame during periods of non-use.

27. A wheeled vehicle support comprising:
a frame;
a front brace coupled to said frame; and
a rear brace coupled to said frame;
wherein said support supports a wheeled vehicle in at least one of the group consisting of a stationary position, an upright position, and combinations thereof; and
wherein at least one of the group consisting of said front brace, said rear brace, and combinations thereof includes at least one aperture to facilitate attachment of a fastening mechanism.

28. A support according to claim 22, wherein said fastening mechanism is at least one of the group consisting of a tie-down strap, a ratchet strap, twine, a bungee cable, and combinations thereof.

29. A wheeled vehicle support comprising:
a frame;
a front brace coupled to said frame, said front brace including at least one ratchet strap brace; and
a rear brace coupled to said frame, said rear brace including at least one ratchet strap brace;
wherein said support supports a wheeled vehicle in at least one of the group consisting of a stationary position, an upright position, and combinations thereof; and
wherein said ratchet strap braces facilitate attachment of at least one ratchet strap to said support.

30. A wheeled vehicle support comprising:
a frame;
a front brace coupled to said frame;
a rear brace coupled to said frame;
at least one retention mechanism for coupling at least one of the group consisting of said front brace, said rear brace, and at least one accessory to said frame;
wherein said frame includes at least two apertures for receiving said at least one retention mechanism; and
wherein said support supports a wheeled vehicle in at least one of the group consisting of a stationary position, an upright position, and combinations thereof.

31. A support according to claim 30, wherein said at least one accessory includes at least one of the group consisting of a stabilizer, a cover, a winch, a spacer, and combinations thereof.
